(19) United States
(12) Patent Application Publication
(10) Pub. No.: US 2004/0224113 A1
(43) Pub. Date: Nov. 11, 2004

(54) Anti-slip tape

(75) Inventors: Clarence J. Haas, North Royalton, OH (US); Raymond C. Buckley, Rocky River, OH (US)

Correspondence Address: James A. Hudak, Esq., 29425 Chagrin Blvd., Suite #304, Cleveland, OH, 44122-4602, US

(73) Assignee: Sure-Foot Industries Corporation

(21) Appl. No.: 10/431,727

(22) Filed: May 9, 2003

(51) Int. Cl. B32B 9/00

(52) U.S. Cl. 428/40.1; 428/143

(57) ABSTRACT

An anti-slip tape having a surface that is substantially non-abrasive permitting it to be readily cleaned is disclosed. The anti-slip tape is comprised of a paper backing layer, a layer of pressure sensitive material, a layer of polyester film, a coating of resinous material, and a layer of fine and medium grade grit particles. The fine and medium grade grit particles are semi-rounded and coated providing a substantially non-abrasive surface.

### TECHNICAL FIELD

The present invention relates, in general, to an anti-slip tape and, more particularly, to an anti-slip tape that can be readily cleaned with a sponge or a mop without damaging the sponge or mop.

### BACKGROUND ART

There are numerous types of anti-slip tapes, anti-slip stair treads and coatings that provide an anti-slip surface. The anti-slip property of these products is typically provided by grit particles within the tape or coating. Such grit particles typically exhibit an abrasive property. In some instances, however, the anti-slip tape or coating may exhibit non-abrasive properties. For example, U.S. Pat. No. 3,527,146 (Garling) discloses an anti-skid coating that incorporates a non-abrasive aggregate. This patent also discloses an anti-skid traffic bearing surface comprising a supporting base with a non-abrasive surface bonded thereto. The non-abrasive property of both the surface coating and the traffic bearing surface is provided by an elastomeric polymer in the form of small solid rubbery particles within the coating or surface. By using solid rubbery particles, rather than grit, a relatively non-abrasive surface results.

An anti-slip tape or pavement marking sheet is disclosed in U.S. Pat. No. 5,536,569 (Lash, et. al.). The pavement marking sheet or tape is comprised of a liner, a pressure sensitive adhesive layer, a base layer and a top layer containing partially embedded glass microspheres and skid-resistant particles. In addition to making the sheet or tape luminescent, the glass microspheres reduce the abrasiveness of the surface of the tape or sheet.

A coating that provides abrasion resistance is disclosed in U.S. Pat. No. 4,356,037 (Novak). In this case, the coating is comprised of a binder having first abrasion-resistant particles of a substantially uniform size and second abrasion-resistant particles of substantially smaller uniform size dispersed therein. The binder and the second abrasion-resistant particles fill the voids between the first abrasion resistant particles. Even though this patent discloses the use of multiple sizes of grit particles to form an abrasion-resistant coating, it makes no reference to applying the coating to a backing material so as to form an anti-slip tape having non-abrasive properties.

In view of the foregoing, it has become desirable to develop an anti-slip tape that utilizes a plurality of grit particle sizes to provide a substantially non-abrasive surface that can be readily cleaned with a sponge or a mop without damaging the sponge or mop.

### SUMMARY OF THE INVENTION

The present invention provides an anti-slip tape that utilizes a plurality of grit particle sizes to provide a substantially non-abrasive surface that can be readily cleaned without damaging the sponge or mop utilized to clean same. The anti-slip tape of the present invention is comprised of a paper backing layer, a layer of pressure sensitive material, a layer of polyester film, a coating of resinous material and a layer of a mixture of fine and medium grade grit particles. The layer of the mixture of fine and medium grade grit particles is comprised of grit particles that are semi-rounded and coated. The smaller grit particles fill the voids between the larger grit particles eliminating any large voids between particles that can trap dirt. The semi-rounded surfaces of the grit particles and the coating on same permits the anti-slip surface of the tape to be readily cleaned with a sponge or a mop without damaging the sponge or mop.

### BRIEF DESCRIPTION OF THE DRAWINGS

FIG. 1 is a cross-sectional view of the anti-slip tape of the present invention.

FIG. 2 is an enlarged cross-sectional view of the anti-slip tape of the present invention illustrating the medium grade grit particles and the fine grade grit particles filling the voids between the medium grade grit particles.

### DESCRIPTION OF THE PREFERRED EMBODIMENT

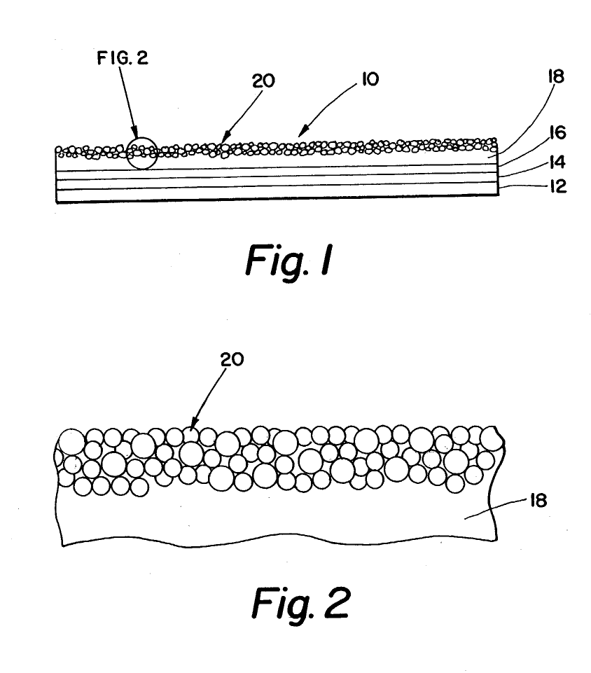

Referring now to the attached drawings where the illustrations are for the purpose of describing the preferred embodiment of the present invention and are not intended to limit the invention described herein, FIG. 1 is a cross-sectional view of the anti-slip tape 10 of the present invention. The anti-slip tape 10 is comprised of a paper backing layer 12, a layer 14 of pressure sensitive material, a layer 16 of polyester film, a coating 18 of resinous material, and a layer 20 of a mixture of fine and medium grade grit particles. The paper backing layer 12 is typically formed from liner paper, such as 90 pound liner paper. The layer 14 of pressure sensitive material typically has a thickness of about 1.9 mils. The layer 16 of polyester film typically has a thickness of about 1.0 mils. The coating 18 of resinous material typically has a thickness of about 6.0 mils. The layer 20 of the mixture of fine and medium grade grit particles is comprised of grit particles that are semi-rounded and coated.

The layer 20 of the mixture of fine and medium grade grit particles is typically comprised of medium and fine grade grit particles in a ratio of about 9:1. Each grade of grit particles is comprised of a range of sizes from 20 mesh to 140 mesh. The medium and fine grade grit particles are mixed together so that a custom blend of grit particles having various mesh screen sizes is achieved. By experimentation, the mesh screen analysis of such a custom blend of grit particles is comprised of approximately 8% 20 mesh, 11% 30 mesh, 49% 40 mesh, 22% 50 mesh, 6% 70 mesh, 3% 100 mesh and 1% 140 mesh. The smaller grit particles fill the voids between the larger grit particles, as shown in FIG. 2. Filling the voids between grit particles eliminates any large voids between grit particles that can trap dirt particles and make the overall surface of the tape too “aggressive”. The semi-rounded surfaces on the grit particles and the coating on same makes the particles less likely to grab or tear a sponge or mop being used to clean the surface of the tape 10. Thus, the surface of the tape 10 acts as an anti-slip surface, however, it can be readily cleaned with a sponge or a mop without damaging the sponge or mop.

Certain modifications and improvements will occur to those skilled in the art upon reading the foregoing. It is understood that all such modifications and improvements have been deleted herein for the sake of conciseness and readability, but are properly within the scope of the following claims.

We claim:

1) An anti-slip tape comprising a backing layer, a pressure sensitive material layer, a polyester film layer, a coating of resinous material and a layer of a first grade of grit particles and a second grade of grit particles, said first grade of grit particles and said second grade of grit particles each having a surface that is semi-rounded in configuration and coated.

2) The anti-slip tape as defined in claim 1 wherein said first grade of grit particles and said second grade of grit particles are in a ratio of about 9:1.

3) The anti-slip tape as defined in claim 1 wherein said first grade of grit particles and said second grade of grit particles are comprised of a range of grit particle sizes from about 20 mesh to about 140 mesh.

4) The anti-slip tape as defined in claim 3 wherein said first grade of grit particles and said second grade of grit particles are blended together to provide a resulting mixture of about 8% 20 mesh, about 11% 30 mesh, about 49% 40 mesh, about 22% 50 mesh, about 6% 70 mesh, about 3% 100 mesh and about 1% 140 mesh.

5) The anti-slip tape as defined in claim 1 wherein said backing layer is comprised of a paper backing layer.
